(19) United States
(12) Patent Application Publication
(10) Pub. No.: US 2026/0229230 A1
(43) Pub. Date: Aug. 6, 2026

(54) METHOD FOR SPEECH RECOGNITION, COMPUTER DEVICE AND STORAGE MEDIUM

(71) Applicant: Beijing Zitiao Network Technology Co., Ltd., Beijing (CN)

(72) Inventors: Lu LIU, Beijing (CN); Lu Huang, Beijing (CN); Jun Zhang, Beijing (CN)

(21) Appl. No.: 19/458,396

(22) Filed: Jan. 23, 2026

(30) Foreign Application Priority Data
Jan. 24, 2025 (CN) 202510122156.5

(51) Int. Cl. G10L 15/22; G10L 15/08

(52) U.S. Cl. CPC G10L 15/22; G10L 15/08; G10L 2015/088

(57) ABSTRACT

A method for speech recognition, a computer device, and a storage medium are provided. The method includes: receiving a speech input by a user; recognizing the speech to determine first content information and intention information corresponding to the speech, and function information associated with the intention information; in response to the first content information recognized not matching the speech, calling a function corresponding to the function information to determine second content information based on the first content information through an application programming interface (API) corresponding to the function; and generating a recognition result of the speech based on the intention information and the second content information.

### CROSS-REFERENCE TO RELATED APPLICATIONS

The present application claims priority to Chinese Patent Application No. 202510122156.5, filed on January 24, 2025, which is incorporated herein by reference in its entirety as a part of the present application.

### TECHNICAL FIELD

The present disclosure relates to the technical field of computers.

### BACKGROUND

Speech recognition technology generally recognizes the input speech as text, so that further processing may be performed based on the recognized text subsequently.

However, the inventor of the present disclosure has found that the accuracy rate of speech recognition is not good in the related art.

### SUMMARY

In the present disclosure, an embodiment of a method for speech recognition is provided, including:

receiving a speech input by a user;

recognizing the speech to determine first content information and intention information corresponding to the speech, and function information associated with the intention information;

in response to the first content information recognized failing to match the speech, calling a function corresponding to the function information to determine second content information based on the first content information through an application programming interface (API) corresponding to the function; and

generating a recognition result of the speech based on the intention information and the second content information.

In the present disclosure, an embodiment of a speech recognition apparatus is provided, including:

a receiving module configured to receive a speech input by a user;

a recognition module configured to recognize the speech to determine first content information and intention information corresponding to the speech, and function information associated with the intention information;

a calling module configured to: in response to the first content information recognized failing to match the speech, call a function corresponding to the function information to determine second content information based on the first content information through an application programming interface (API) corresponding to the function; and

a generation module configured to generate a recognition result of the speech based on the intention information and the second content information.

In the present disclosure, an embodiment of a computer device is provided, including one or more processors, a memory, and one or more programs, where the one or more programs are stored in the memory and executed by the one or more processors, and the programs include instructions for executing the method for speech recognition according to the present disclosure.

In the present disclosure, an embodiment of a non-volatile computer-readable storage medium containing a computer program is provided, where the computer program, when executed by one or more processors, causes the processors to execute the method for speech recognition according to the present disclosure.

In the present disclosure, an embodiment of a computer program product is provided, including a computer program, where the computer program, when executed by a processor, implements the method for speech recognition according to the present disclosure.

### BRIEF DESCRIPTION OF DRAWINGS

In order to explain the technical solutions in the present disclosure or the related art more clearly, a brief introduction will be made to the accompanying drawings which are required to be used in the description of the examples or the related art, and it is obvious that the drawings in the description below are merely examples of the present disclosure, and for those ordinarily skilled in the art, other drawings may be obtained according to these drawings without involving any inventive effort.

FIG. 1 shows a schematic diagram of an exemplary system provided in an example of the present disclosure.

FIG. 2 shows a schematic flow diagram of an exemplary method provided in an example of the present disclosure.

FIG. 3 shows a schematic flow diagram of another exemplary method provided in an example of the present disclosure.

FIG. 4 shows a schematic diagram of an exemplary apparatus provided in an example of the present disclosure.

FIG. 5 shows a schematic diagram of a hardware structure of an exemplary computer device provided in an example of the present disclosure.

### DETAILED DESCRIPTION

In order to make the objects, technical solutions and advantages of the present disclosure clearer and more understandable, the present disclosure will be described in further detail below in conjunction with specific examples with reference to the accompanying drawings.

It should be noted that unless otherwise defined, technical or scientific terms used in the examples of the present disclosure should be given their ordinary meaning as understood by those ordinarily skilled in the art to which the present disclosure belongs. The use of “first”, "second", and similar words in the examples of the present disclosure do not denote any order, quantity or importance, but rather are used for distinguishing different constituent parts. The words “including” or “containing”, and the like mean that the presence of an element or item preceding the word covers the presence of the element or item listed after the word and equivalents thereof, but does not exclude other elements or items. The words “connection” or “connected with each other”, and the like are not limited to physical or mechanical connection, but may include electrical connection, either direct or indirect connection. The terms “upper”, “lower”, “left”, “right”, and the like are used only for indicating a relative positional relationship, and when an absolute position of the described object changes, the relative positional relationship may change accordingly.

It will be understood that prior to the use of the technical solutions of various examples of the present disclosure, a user will be informed of the type, the scope of use, the use scene, and the like of personal information involved in an appropriate manner, and authorization will be granted by the user.

For example, in response to receiving an active request of the user, prompt information is sent to the user to explicitly prompt the user that the operation requested to be executed by the user will require the acquisition and use of personal information of the user. Thus, the user may autonomously select whether to provide the personal information to software or hardware, such as an electronic device, an application, a server or a storage medium which executes the operation of the technical solution of the present disclosure according to the prompt information.

As an optional but non-limiting implementation mode, the mode in which the prompt information is sent to the user in response to receiving the active request of the user may be, for example, a mode of a pop-up window, and the prompt information may be presented in the pop-up window in a mode of text. In addition, the pop-up window may also carry a selection control for the user to select either “agree” or “disagree” to provide the personal information to the electronic device.

It should be understood that the above processes of notification and acquisition of the authorization of the user are merely illustrative and do not constitute a limitation on the implementation mode of the present disclosure, and other modes satisfying relevant laws and regulations may also be applied in the implementation mode of the present disclosure.

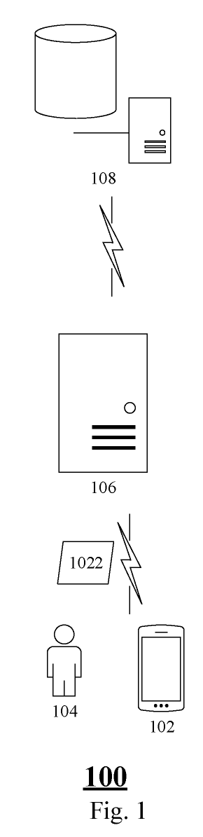

FIG. 1 shows a schematic diagram of an exemplary system 100 provided in an example of the present disclosure.

As shown in FIG. 1, the system 100 may include a terminal device 102, a server 106 and a database server 108. A medium (such as a network) which provides a communication link may be included between the terminal device 102 and the server 106 and the database server 108. The network may include various connection types, such as wired and wireless communication links, or an optical fiber cable, and the like.

The terminal device 102 may have various applications (APP) or software installed thereon, for example, a speech recognition type application, an audio type application, a collaborative office type application, an image processing type application, a video conference type application, a book reading type application, a video type application, a social type application, a payment type application, a web browser, an instant messenger, and the like. In some examples, these applications may all be used for recognizing the speech.

The terminal device 102 herein may be either hardware or software. When the terminal device 102 is hardware, it may be various electronic devices having display screens including, but not limited to, a smartphone, a tablet computer, an e-book reader, an MP3 player, a laptop, a desktop personal computer (PC), and the like. When the terminal device 102 is software, it may be installed in the electronic devices listed above, and it may be implemented as a plurality of software or software modules (such as being used for providing distributed services) or implemented as a single software or software module, which is not specifically limited herein.

The server 106 may be a server which provides various services, such as a background server which provides support for various applications displayed on the terminal device 102. The database server 108 may also be a database server which provides various services. It should be understood that the database server 108 may not be provided in the system 100 under the condition that the server 106 may implement the related functions of the database server 108.

The server 106 and the database server 108 herein may be either hardware or software as well. When they are hardware, they may be implemented as a distributed server cluster consisting of a plurality of servers, and may also be implemented as a single server. When they are software, they may be implemented as a plurality of software or software modules (such as being used for providing distributed services), and may also be implemented as a single software or software module, which is not specifically limited herein.

It should be noted that a method for editing documents provided in an example of the present disclosure may be executed by the server 106. It should be understood that the number of the terminal device, the user, the server and the database server in FIG. 1 is merely illustrative. There may be any number of terminal devices, users, servers and database servers according to the implementation needs.

In one example, a speech recognition type application or software may be installed in the terminal device 102, and the user 104 may perform speech recognition by utilizing the application or software installed in the terminal device 102.

In a more specific scene, the user 104 may perform speech recognition by utilizing an APP of an artificial intelligence (AI) model in the terminal device 102. For example, a command is output by inputting a segment of speech so that the AI model executes corresponding operation based on the command. As shown in FIG. 1, the speech 1022 is uploaded to the server 106, firstly speech recognition may be performed on the speech 1022, the server 106 may call a speech recognition model to convert the speech 1022 into text, and then corresponding operation is executed based on the information of the text. However, as described above, the speech recognition model in the related art has a low recognition accuracy rate.

In view of the foregoing, an example of the present disclosure provides a method for speech recognition to solve or partially solve the above problem.

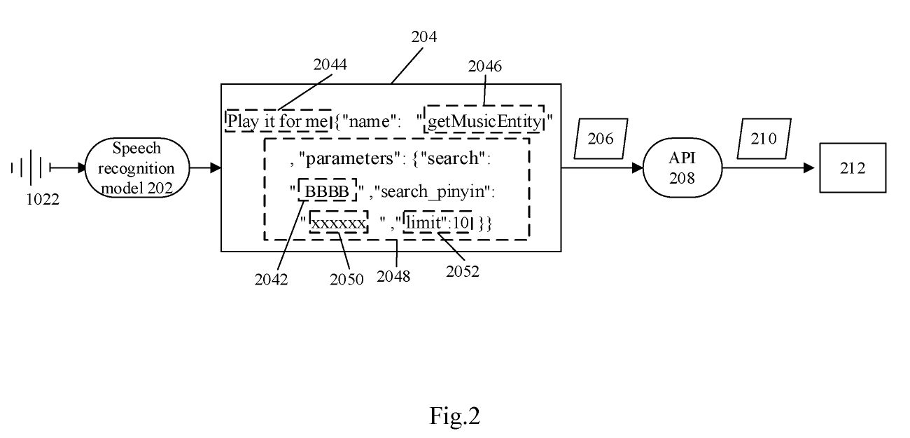

FIG. 2 shows a schematic flow diagram of an exemplary method 200 provided in an example of the present disclosure. The method 200 may be used for speech recognition. Optionally, the method 200 may be implemented by the server 106 in FIG. 1, and may also be implemented by the system 100 in FIG. 1.

As shown in FIG. 2, illustratively, the user 104 may input a segment of speech 1022 by utilizing the terminal device 102 for speech recognition.

Optionally, the speech 1022 may be a segment of speech spoken by the user 104 or a segment of speech in an environment collected through a microphone of the terminal device 102 by the user 104, and may also be a segment of speech selected locally by the user 104 from the terminal device 102, and the like.

The terminal device 102 may send the speech 1022 to the server 106 for speech recognition work.

After receiving the speech 1022, the server 106 may recognize the speech 1022. Optionally, a recognition mode may be recognition based on the AI model, may also be recognition based on a speech template matching mode, and may further be a method for speech recognition based on dynamic time warping (DTW).

As an optional example, as shown in FIG. 2, the server 106 may call the speech recognition model 202 to recognize the speech 1022.

Optionally, the speech recognition model 202 may be a speech recognition model based on deep learning, for example, a convolutional neural network (CNN), a recurrent neural network (RNN) and a variant thereof, a long short-term memory network (LSTM), and the like; the speech recognition model 202 may also be a speech recognition model based on a hidden Markov model (HMM); and the speech recognition model 202 may also be an end-to-end based speech recognition model, such as Transformer and Conformer.

It should be understood that if the speech recognition model 202 is intended to perform recognition accurately, it is necessary to train the model by utilizing various corpuses. However, the inventor of the present disclosure has found that with the development of science and technology and the accessibility of human-to-human communication brought by Internet technology, new vocabularies keep emerging. Especially in the process of speech interaction, some hot words, knowledge in professional fields, and the like used by the user 104 are not covered in the training corpus of the speech recognition model 202 in time, which makes the speech recognition model 202 difficult to recognize the contents which are not covered by the training corpus, thereby resulting in the impact of the recognition accuracy rate.

In the related art, a recognition effect of this part is improved by adding more and more time-sensitive training data or adding field-specific training data. However, the inventor of the present disclosure has found that in this mode, the costs of data collection, labeling and expansion are relatively high, and the computational cost and time cost of retraining a large model are enormous. Therefore, constantly expanding the training data and constantly fine-tuning the model is not a long-term solution.

In view of the foregoing, as shown in FIG. 2, the speech recognition model 202 in the example of the present disclosure may output first content information 2042 corresponding to the speech 1022, intention information 2044, and function information 2046 associated with the intention information 2044 when recognizing the speech, where the function information 2046 may include a function, and the function may be used for calling a corresponding application programming interface (API) 208 to determine second content information 210 based on the first content information 2042.

Illustratively, as shown in FIG. 2, an output 204 of the speech recognition model 202 may include the intention information 2044 and the function information 2046 associated with the intention information 2044, and may also include parameter information 2048 for being transferred to the API 208, and the parameter information 2048 further includes the first content information 2042 so that after the parameter information 2048 is transferred to the API 208, the API 208 may generate the second content information 210 based on the first content information 2042.

In some examples, in order to enable the speech recognition model 202 to generate the content in the format of the output 204 based on the speech 1022, the speech recognition model 202 may be trained by utilizing training data in a format similar to this format.

For example, firstly some query requests in a speech format may be generated in advance, content information and intention information in these speeches are determined, and then corresponding function information is associated with the intention information, so as to generate a series of training data.

Illustratively, it is assumed that the content of the speech is “play AAAA”, where the content information is the song “AAAA” and the intention information is “play”. Since the intention information is “play”, the function information associated with the intention information may be determined as a function for calling the API related to music play. Then, the information is used as a label of the speech, and the labeled speech is training data. It should be understood that the training data is set only by taking playing music as an example herein, according to different intentions, there may be training data in various fields, for example, novels, live broadcasts, and the like, and the function information corresponding to the intention information of the training data in these different fields may be the APIs in the fields, so that the second content information may be generated based on the first content information in the field.

After obtaining the training data, the speech recognition model 202 may be trained by utilizing these training data, or on the basis of the speech recognition model which has been trained by utilizing a general corpus in advance, the speech recognition model may be continuously trained by utilizing the above training data to obtain the model 202, so that the trained model 202 may output the first content information and the intention information corresponding to the speech, and the function information associated with the intention information based on the speech.

In some examples, if the speech recognition model 202 is a large language model, in order to enable the model 202 to perform output according to the format of the output 204, a prompt may be set for the model 202, and an output format of the model may be specified in the prompt, so that the model 202 may generate a format of the output 204 after recognizing the speech 1022, so as to ensure the standardization of the output format, and then better achieve the calling of the API.

Returning to FIG. 2, after obtaining the output 204, the server 106 may determine whether the first content information 2042 recognized matches the speech 1022 to determine whether the first content information 2042 is recognized correctly.

In some examples, it may be determined whether the first content information 2042 matches the speech 1022 by calculating a confidence of the first content information 2042. For example, when the confidence is lower than a confidence threshold, it is considered that the first content information 2042 does not match the speech 1022, and when the confidence is equal to or higher than the confidence threshold, it is considered that the first content information 2042 matches the speech 1022.

However, the inventor of the present disclosure has found that determining whether the first content information 2042 matches the speech 1022 by adopting a mode of calculating the confidence may result in an inaccurate calculation result due to the calculation mode of the confidence and then not be able to determine whether the first content information 2042 matches the speech 1022 well.

In view of the foregoing, in some examples, keywords associated with various types of intention information may be stored in the database server 108 in advance. Then, after obtaining the intention information 2044, a plurality of keywords associated with the intention information 2044 may be found from the database server 108, and whether the first content information 2042 can match these keywords is determined. If the first content information 2042 does not match the plurality of keywords associated with the intention information 2044, it may be determined that the first content information 2042 recognized does not match the speech 1022, and if the first content information 2042 matches a target keyword among the plurality of keywords associated with the intention information 2044, it may be determined that the first content information 2042 recognized matches the speech 1022.

In this way, whether the first content information 2042 matches the speech 1022 may be determined quickly, and a matching result is relatively accurate. It is only necessary to associate corresponding keywords with specific intention information, and only necessary to update the keywords as needed subsequently, without needing to perform a time-consuming and laborious model training process.

Optionally, a plurality of tables may be stored in the database server 108 in advance, each table includes a plurality of keywords associated with specific intention information, for example, the table associated with a music playing intention may include keywords such as a song name, a singer, a lyricist and a composer, etc., and the table associated with novel reading intention may include keywords such as a book title, an author, etc. Then, after obtaining the intention information 2044, the table corresponding to the intention information 2044 may be found, and whether the first content information 2042 can match the keywords in the table may be determined by means of table lookup. When the first content information 2042 does not match a plurality of keywords in the table, it may be determined that the first content information 2042 recognized does not match the speech 1022, and when the first content information 2042 matches a target keyword among the plurality of keywords in the table, it may be determined that the first content information 2042 recognized matches the speech 1022.

In this way, whether the first content information 2042 matches the speech 1022 may be determined quickly by means of table lookup, and a matching result is relatively accurate. It is only necessary to configure the keywords in the table corresponding to the specific intention information, and updating the table only needs to update the keywords, without needing to perform a time-consuming and laborious model training process.

In some examples, the plurality of keywords include a plurality of words and/or phrases in a field associated with the intention information which are searched for more than a preset number of times (such as 1,000 times and 10,000 times) within a preset time period (such as within the last half year, within the last three months, within the last month, and within the last week). In other words, the keywords in the table may be hot words, namely, the words or phrases which are searched more frequently, for example, a popular singer and a hit song in the field of music playing, and the like. If the first content information 2042 does not match these hot words, it indicates that the first content information 2042 may belong to unpopular vocabularies, the model 202 may have a relatively low recognition accuracy rate, and a corresponding API may be called to introduce more knowledge, so as to make the recognition of some unpopular vocabularies or special words more accurate.

Further, as an optional example, as shown in FIG. 2, when the first content information 2042 recognized does not match the speech 1022, a function corresponding to the function information 2046 may be called to determine second content information 210 based on the first content information 2042 through the API 208 corresponding to the function, and then a recognition result 212 of the speech 1022 is generated based on the intention information 2044 and the second content information 210. In this way, when the first content information 2042 recognized does not match the speech 1022, more knowledge in the field is introduced by calling the API 208 corresponding to the intention information 2044, so that the recognition of some unpopular vocabularies or special words is more accurate.

In some examples, as shown in FIG. 2, when calling the API 208, the first content information 2042 may be transferred to the API 208 as a parameter 206 of the API 208, so that the API 208 may return the second content information 210 based on the parameter 206. Optionally, the parameter information 2048 may further include pinyin information 2050 corresponding to the first content information 2042, so that the API 208 may return the second content information 210 based on the first content information 2042 and the pinyin information 2050 in the parameter 206 to improve the accuracy of the second content information 210.

In some examples, the API 208 may be used for performing a fuzzy search based on the first content information 2042 and/or the pinyin information 2050 to determine the second content information 210, so that the first content information 2042 which is recognized mistakenly may be corrected.

The fuzzy search is a search function which allows the user to search for related results according to the similarity of keywords when inputting the keywords. Unlike a conventional accurate matching search, the fuzzy search can handle typographical errors, spelling variants and partial matching, thereby enhancing the user experience and satisfaction. This technology is particularly important when handling a large amount of data and information, as it may help the users quickly find the contents they need, even if they do not accurately remember the correct spelling or full names of search terms.

The functions of the fuzzy search may include:

1. handling of spelling errors: even if keywords input by the user are misspelled, the fuzzy search can also find correct results;

2. partial matching: part of the keywords input by the user can also match complete contents, for example, the input “aple” may match “apple” and “pineapple”;

3. synonym and near-synonym matching: the fuzzy search may recognize synonyms and near-synonyms to provide more comprehensive search results, for example, the input “happy” may match related contents such as “joyful”; and

4. dynamic word stock and word segmentation: when handling Chinese data, the fuzzy search may achieve more flexible search through pinyin word segmentation and fuzzy matching, for example, when searching for “stir-fried bok choy”, the pinyin “qingchaoxiaobaicai” may be accepted.

In some examples, the fuzzy search may obtain a plurality of words and/or phrases similar to the first content information 2042 based on the first content information 2042, and in order to avoid unlimited expansion of the near-synonyms, the parameter information 2048 may further include number limitation information 2052 which is added to the parameter 206 to limit the number of the near-synonyms (candidate content information) returned by the API 208. After getting a plurality of pieces of candidate content information, the server 106 may score the plurality of pieces of candidate content information to select the information most matching the speech 1022 therefrom as the second content information 210.

After obtaining the second content information 210, in some examples, the intention information 2044 and the second content information 210 may be input into the speech recognition model 202 to guide the model 202 to output and obtain the recognition result 212 of the speech 1022. At this time, the second content information 210 is relatively accurate recognition information, and the output of the model 202 again will obtain a more accurate recognition result 212.

However, the inventor of the present disclosure has discovered that it is necessary to consume computing resources once more by adopting a mode of calling the model 202 again, which may result in a response delay of the system 100. Therefore, in some examples, the server 106 may directly splice the intention information 2044 and the second content information 210 to generate the recognition result 212 of the speech. At this time, the second content information 210 is relatively accurate recognition information, and a more accurate recognition result 212 may also be obtained by directly splicing the intention information 2044 and the second content information 210, without needing to call the model 202 again.

As described above, the model 202 has a relatively high recognition accuracy rate for some contents, and therefore, as another optional example, if the first content information 2042 recognized matches the speech 1022, the recognition result 212 of the speech 1022 may be generated based on the intention information 2044 and the first content information 2042, and the recognition result 212 may also be relatively accurate.

As a more specific instance, as shown in FIG. 2, assuming that the content of the speech 1022 is “play AAAA for me”, the speech recognition model 202 recognizes the speech 1022 as “play BBBB for me”, and provides the output 204. The server 106 utilizes “BBBB” to perform matching in the table corresponding to the music playing intention, and finds that there is no keyword which may match, which indicates that the first content information 2042 recognized by the model 202 does not match the speech 1022, then the API 208 corresponding to the function information 2046 may be called, the parameter 206 (such as “args: BBBB/xxxxxx”) (xxxxxx being the pronunciation of “AAAA”) for being transferred to the API 208 is generated based on the parameter information 2048 in the output 204, and the API 208 may perform a fuzzy search based on the parameter 206 to obtain the second content information 210 (such as “AAAA”). Finally, the server 106 may splice the intention information 2044 and the second content information 210 into the recognition result 212 (such as “play AAAA for me”) for output. It should be understood that if the model 202 recognizes the speech 1022 as “play AAAA for me”, the server 106 utilizes “AAAA” to perform matching in the table corresponding to the music playing intention and may match the keyword “AAAA”, and then at this time, there is no need to call the API 208 again, while the intention information 2044 and the first content information 2042 may be directly spliced into the recognition result 212 for output. In this mode, on the basis of ensuring the accuracy of the recognition result 212, there is no need to constantly expand the training data or constantly fine-tune the model, thereby saving the computing resources and human resources.

By applying the above method to the speech recognition technology by the inventor of the present disclosure, in the same test set, the accuracy rate of speech recognition adopting the above method may be significantly improved with respect to the accuracy rate of speech recognition adopting the related art.

In some examples, after obtaining the recognition result 212, the server 106 may also return the recognition result 212 to the terminal device 102, the terminal device 102 may display the recognition result 212 on a screen after receiving the recognition result 212, and the user 104 may see the recognition result 212. In some examples, the terminal device 102 may also perform subsequent operation based on the recognition result 212, for example, send a request of playing corresponding music to the server 106, and the server 106 returns the corresponding music to the terminal device 102 for playing, so that the user 104 may achieve the automatic playing of the corresponding music by inputting the speech 1022 to the terminal device 102.

It can be seen from the above examples that in the method for speech recognition provided in the examples of the present disclosure, for vocabularies which cannot be recognized in the recognition process, more knowledge is introduced by calling the corresponding API to make the recognition of some special words, unfamiliar words, and the like more accurate. This method may correct some field recognition errors online, especially when involving special words and more time-sensitive words which may not be available in the training data of the large language model, this part of data can be recalled without training.

It should be noted that the method in the examples of the present disclosure may be executed by a single device, such as a computer or server. The method of this example may also be applied to a distributed scene and completed by a plurality of devices cooperating with each other. Under the condition of such a distributed scene, one device of the plurality of devices may execute only a certain step or a plurality of steps in the method of the examples of the present disclosure, and the plurality of devices may interact with each other to complete the described method.

It should be noted that some examples of the present disclosure have been described above. Other examples are within the scope of the appended claims. Under some conditions, the acts or steps recited in the claims may be executed in an order different from that of the examples described above and may still achieve desired results. In addition, the processes depicted in the accompanying drawings do not necessarily require the shown specific order or sequential order to achieve the desired results. In some embodiments, multi-tasking and parallel processing may also be possible or may be advantageous.

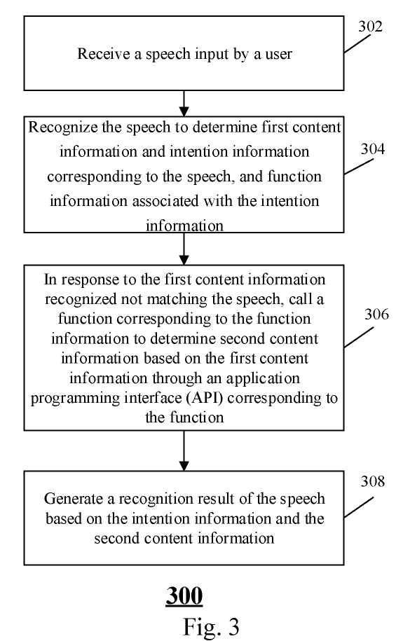

An example of the present disclosure further provides a method for speech recognition. FIG. 3 shows a schematic diagram of another exemplary method 300 provided in an example of the present disclosure. As shown in FIG. 3, the method 300 may further include the following steps.

At step 302, receiving a speech (such as the speech 1022 in FIG. 2) input by a user.

At step 304, recognizing the speech to determine first content information (such as the information 2042 in FIG. 2) and intention information (such as the information 2044 in FIG. 2) corresponding to the speech, and function information (such as the information 2046 in FIG. 2) associated with the intention information.

At step 306, in response to the first content information recognized not matching the speech, calling a function corresponding to the function information to determine second content information (such as the information 210 in FIG. 2) based on the first content information through an application programming interface (API) (such as the API 208 in FIG. 2) corresponding to the function.

At step 308, generating a recognition result (such as the recognition result 212 in FIG. 2) of the speech based on the intention information and the second content information.

In the method for speech recognition provided in the example of the present disclosure, the speech is recognized to determine the first content information and the intention information corresponding to the speech, and the function information associated with the intention information, when the first content information recognized does not match the speech, the function corresponding to the function information is called to determine the second content information based on the first content information through the application programming interface (API) corresponding to the function, and then the recognition result of the speech is generated based on the intention information and the second content information to obtain a more accurate recognition result.

In some examples, the method 300 further includes:

obtaining a plurality of keywords associated with the intention information;

in response to the first content information recognized not matching the plurality of keywords, determining that the first content information recognized does not match the speech; or

in response to the first content information recognized matching a target keyword among the plurality of keywords, determining that the first content information recognized matches the speech.

In this way, whether the first content information matches the speech may be determined quickly, and a matching result is relatively accurate. It is only necessary to configure the keywords in the table corresponding to the specific intention information, and updating the table only needs to update the keywords, without needing to perform a time-consuming and laborious model training process.

In some examples, the plurality of keywords include a plurality of words and/or phrases in a field associated with the intention information which are searched for more than a preset number of times within a preset time period. By adding hot words into the table as keywords, some words with higher search frequencies may be recognized at once to ensure the processing efficiency, while for words with lower word frequencies, the recognition accuracy rate is usually lower due to the unpopularity thereof. The second content information is obtained by means of calling the API, so that the recognition accuracy rate may be improved.

In some examples, recognizing the speech to determine first content information and intention information corresponding to the speech, and function information associated with the intention information, includes: calling a speech recognition model to output the first content information and the intention information corresponding to the speech, and the function information associated with the intention information based on the speech. In this way, the efficiency and accuracy rate of initial recognition may be improved by performing speech recognition through the speech recognition model.

In some examples, generating a recognition result of the speech based on the intention information and the second content information, includes: inputting the intention information and the second content information into the speech recognition model to output and obtain the recognition result of the speech. At this time, the second content information is relatively accurate recognition information, and the output of the model again will obtain a more accurate recognition result.

In some examples, determining second content information based on the first content information through an application programming interface (API) corresponding to the function, includes: transferring the first content information to the API as a parameter (such as the parameter 206 in FIG. 2) of the API; and receiving the second content information returned by the API based on the parameter, so that the API may return the second content information corresponding to the first content information based on the received parameter.

In some examples, the API is used for performing a fuzzy search based on the first content information to determine the second content information. Unlike a conventional accurate matching search, the fuzzy search can handle typographical errors, spelling variants and partial matching, thereby enhancing the user experience and satisfaction. This technology is particularly important when handling a large amount of data and information, as it may help the users quickly find the contents they need, even if they do not accurately remember the correct spelling or full names of search terms.

In some examples, generating a recognition result of the speech based on the intention information and the second content information, includes: splicing the intention information and the second content information to generate the recognition result of the speech. At this time, the second content information is relatively accurate recognition information, and a more accurate recognition result may also be obtained by directly splicing the intention information and the second content information, without needing to call the speech recognition model again, thereby reducing the delay and improving the reaction speed.

In some examples, the method 300 further includes: in response to the first content information recognized matching the speech, generating the recognition result of the speech based on the intention information and the first content information. At this time, the recognition accuracy rate of the first content information is relatively high, and the recognition result may also be relatively accurate.

In some examples, the intention information includes an intention related to music playing, and the first content information includes at least one selected from the group of a song name, a singer, a lyricist and a composer. In this way, applying the method 300 to the music playing service may increase the recall rate, thereby being beneficial to enhancing the user experience.

It should be noted that the method in the examples of the present disclosure may be executed by a single device, such as a computer or server. The method of this example may also be applied to a distributed scene and completed by a plurality of devices cooperating with each other. Under the condition of such a distributed scene, one device of the plurality of devices may execute only a certain step or a plurality of steps in the method of the examples of the present disclosure, and the plurality of devices may interact with each other to complete the described method.

It should be noted that some examples of the present disclosure have been described above. Other examples are within the scope of the appended claims. Under some conditions, the acts or steps recited in the claims may be executed in an order different from that of the examples described above and may still achieve desired results. In addition, the processes depicted in the accompanying drawings do not necessarily require the shown specific order or sequential order to achieve the desired results. In some embodiments, multi-tasking and parallel processing may also be possible or may be advantageous.

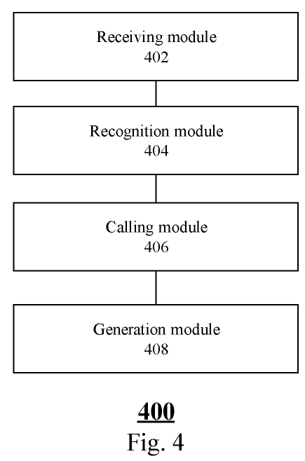

An example of the present disclosure further provides a speech recognition apparatus. FIG. 4 shows a schematic diagram of an exemplary apparatus 400 provided in an example of the present disclosure. As shown in FIG. 4, the apparatus 400 may be used for implementing the method 200 or the method 300, and may further include the following modules:

a receiving module 402 configured to receive a speech input by a user;

a recognition module 404 configured to recognize the speech to determine first content information and intention information corresponding to the speech, and function information associated with the intention information;

a calling module 406 configured to: in response to the first content information recognized not matching the speech, call a function corresponding to the function information to determine second content information based on the first content information through an application programming interface (API) corresponding to the function; and

a generation module 408 configured to generate a recognition result of the speech based on the intention information and the second content information.

In some examples, the recognition module 404 is configured to:

obtaining a plurality of keywords associated with the intention information;

in response to the first content information recognized not matching the plurality of keywords, determining that the first content information recognized does not match the speech; or

in response to the first content information recognized matching a target keyword among the plurality of keywords, determining that the first content information recognized matches the speech.

In some examples, the plurality of keywords include a plurality of words and/or phrases in a field associated with the intention information which are searched for more than a preset number of times within a preset time period.

In some examples, the recognition module 404 is configured to call a speech recognition model to output the first content information and the intention information corresponding to the speech, and the function information associated with the intention information based on the speech.

In some examples, the generation module 408 is configured to input the intention information and the second content information into the speech recognition model to output and obtain the recognition result of the speech.

In some examples, the calling module 406 is configured to:

transfer the first content information to the API as a parameter of the API; and

receive the second content information returned by the API based on the parameter.

In some examples, the API is configured to perform a fuzzy search based on the first content information to determine the second content information.

In some examples, the generation module 408 is configured to splice the intention information and the second content information to generate the recognition result of the speech.

In some examples, the generation module 408 is configured to: in response to the first content information recognized matching the speech, generate the recognition result of the speech based on the intention information and the first content information.

In some examples, the intention information includes an intention related to music playing, and the first content information includes at least one selected from the group of a song name, a singer, a lyricist and a composer.

For the convenience of description, when the above apparatus is described, the apparatus is divided into various modules according to functions for respective description. Of course, the functions of various modules may be implemented in the same one or a plurality of software and/or hardware when implementing the present disclosure.

The apparatus in the above examples is used for implementing the corresponding method 200 or method 300 in any one of the above examples, and has the beneficial effects of the corresponding method examples, which will not be described in detail herein.

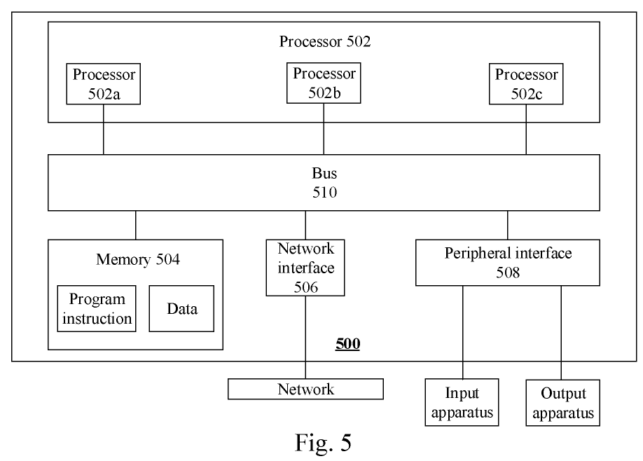

An example of the present disclosure further provides a computer device for implementing the above method 200 or method 300. FIG. 5 shows a schematic diagram of a hardware structure of an exemplary computer device 500 provided in an example of the present disclosure. The computer device 500 may be used for implementing the server 106 in FIG. 1, and may also be used for implementing the terminal device 102 in FIG. 1. In some scenes, the computer device 500 may also be used for implementing the database server 108 in FIG. 1.

As shown in FIG. 5, the computer device 500 may include: a processor 502, a memory 504, a network module 506, a peripheral interface 508 and a bus 510, where the processor 502, the memory 504, the network module 506 and the peripheral interface 508 are communicatively connected with one another through the bus 510 inside the computer device 500.

The processor 502 may be a central processing unit (CPU), a graphics processing unit (GPU), a neural network processing unit (NPU), a microcontroller unit (MCU), a programmable logic device, a digital signal processor (DSP), an application specific integrated circuit (ASIC), or one or more integrated circuits. The processor 502 may be used for executing the functions related to the technology described in the present disclosure. In some examples, the processor 502 may further include a plurality of processors integrated into a single logical component. For example, as shown in FIG. 5, the processor 502 may include a plurality of processors 502a, 502b and 502c.

The memory 504 may be configured for storing data (such as instructions and computer codes). As shown in FIG. 5, the data stored in the memory 504 may include program instructions (such as program instructions for implementing the method 200 or method 300 in the examples of the present disclosure) and data to be processed (for example, the memory may store configuration files of other modules, and the like). The processor 502 may also access the program instructions and data stored in the memory 504 and execute the program instructions to perform operation on data to be processed. The memory 504 may include a volatile storage apparatus or a non-volatile storage apparatus. In some examples, the memory 504 may include a random-access memory (RAM), a read-only memory (ROM), an optical disk, a magnetic disk, a hard disk, a solid-state disk (SSD), a flash memory, a memory stick, and the like.

The network interface 506 may be configured for providing the computer device 500 with communications with other external devices via a network. The network may be any wired or wireless network capable of transmitting and receiving data. For example, the network may be a wired network, a local wireless network (such as Bluetooth, WiFi, a near-field communication (NFC), and the like), a cellular network, the Internet, or a combination of the above. It should be understood that the type of network is not limited to the specific instances described above.

The peripheral interface 508 may be configured for connecting the computer device 500 with one or more peripheral apparatuses to achieve information input and output. For example, the peripheral apparatuses may include input apparatus such as a keyboard, a mouse, a touch pad, a touch screen, a microphone and various types of sensors, as well as output apparatus such as a display, a speaker, a vibrator and an indicator light.

The bus 510 may be configured for transmitting information between various components (such as the processor 502, the memory 504, the network interface 506 and the peripheral interface 508) of the computer device 500, for example, an internal bus (such as a processor-memory bus), an external bus (such as a USB port and a PCI-E bus), and the like.

It should be noted that although the architecture of the computer device 500 described above shows only the processor 502, the memory 504, the network interface 506, the peripheral interface 508 and the bus 510, the architecture of the computer device 500 may further include other components required for achieving normal running in a specific implementation process. In addition, those skilled in the art will understand that the architecture of the computer device 500 described above may include only the components required for implementing the solutions in the examples of the present disclosure, and may not necessarily include all of the components shown in the drawings.

Based on the same inventive concept, corresponding to the method in any of the above examples, the present disclosure further provides a non-transitory computer-readable storage medium storing computer instructions for causing a computer to execute the method 200 or method 300 of any one of the above examples.

The computer-readable medium in this example includes permanent and non-permanent, removable and non-removable media, and may achieve information storage by any method or technology. The information may be computer-readable instructions, data structures, modules of programs, or other data. Instances of storage media of the computer include, but are not limited to, a phase-change random access memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technology, a compact disc read-only memory (CD-ROM), a digital versatile disc (DVD) or other optical storage and magnetic cassette tapes, magnetic tape-magnetic disk storage or other magnetic storage devices, or any other non-transmission media, and may be used for storing information which may be accessed by the computing device.

The computer instructions stored in the storage medium of the above example are used for causing the computer to execute the method 200 or method 300 of any one of the above examples, and have the beneficial effects of the corresponding method examples, which will not be described in detail herein.

Based on the same inventive concept, corresponding to the method 200 or method 300 in any of the above examples, the present disclosure further provides a computer program product, including a computer program. In some examples, the computer program is executable by one or more processors to cause the processors to execute the described method 200 or method 300. Corresponding to an execution subject to which various steps in various examples of the method 200 or method 300 corresponds, the processor executing the corresponding steps may belong to the corresponding execution subject.

In some examples, the computer program product includes a program module for resolving operational conflicts, the program module can be compiled into a binary instruction set (such as wasm) based on a stack-based virtual machine and deployed in a terminal device and/or compiled into a static library and deployed in a server.

The computer program product in the above example is used for causing a processor to execute the method 200 or method 300 of any one of the above examples, and has the beneficial effects of the corresponding method examples, which will not be described in detail herein.

Those ordinarily skilled in the art should understand that the discussion of any of the above examples is exemplary only, and is not intended to imply that the scope (including the claims) of the present disclosure is limited to these instances; and combinations of the features in the above examples or in different examples may also be made within the concept of the present disclosure, the steps may be implemented in any order, and there are many other variations in different aspects of the examples of the present disclosure as described above, which are not provided in detail for the sake of clarity.

Additionally, for simplicity of illustration and discussion, and in order not to obscure the examples of the present disclosure, well-known power/ground connection with integrated circuit (IC) chips and other components may be or may not be shown in the provided drawings. In addition, the apparatuses may be shown in the form of block diagrams, so as to avoid obscuring the examples of the present disclosure, and this takes into account the fact that details concerning the embodiments of these apparatuses of the block diagrams are highly dependent upon a platform to be used for implementing the examples of the present disclosure (namely, these details should be completely within the scope which may be understood by those skilled in the art). Under the condition that specific details (such as circuits) are set forth to describe the illustrative examples of the present disclosure, it will be apparent to those skilled in the art that the examples of the present disclosure may be implemented without these specific details or with variations of these specific details. Therefore, these descriptions should be regarded as illustrative rather than restrictive.

While the present disclosure has been described in conjunction with the specific examples of the present disclosure, many substitutions, modifications and variations of these examples will be apparent to those ordinarily skilled in the art in light of the foregoing description. For example, the discussed examples may be used for other memory architecture (such as a dynamic RAM (DRAM)).

The examples of the present disclosure are intended to cover all such substitutions, modifications and variances which fall within the broad scope of the appended claims. Therefore, any omission, modification, equivalent substitution, improvement, and the like made within the spirit and principles of the examples of the present disclosure should be included within the scope of protection of the present disclosure.

1. A method for speech recognition, comprising:
receiving a speech input by a user;
recognizing the speech to determine first content information and intention information corresponding to the speech, and function information associated with the intention information;
in response to the first content information recognized failing to match the speech, calling a function corresponding to the function information to determine second content information based on the first content information through an application programming interface (API) corresponding to the function; and
generating a recognition result of the speech based on the intention information and the second content information.

2. The method of claim 1, further comprising:
obtaining a plurality of keywords associated with the intention information;
in response to the first content information recognized failing to match the plurality of keywords, determining that the first content information recognized fails to match the speech; or
in response to the first content information recognized matching a target keyword among the plurality of keywords, determining that the first content information recognized matches the speech.

3. The method of claim 2, wherein the plurality of keywords comprise at least one selected from the group consisting of a plurality of words and a plurality of phrases in a field associated with the intention information which are searched for more than a preset number of times within a preset time period.

4. The method of claim 1, wherein the recognizing the speech to determine first content information and intention information corresponding to the speech, and function information associated with the intention information, comprises:
calling a speech recognition model to output the first content information and the intention information corresponding to the speech, and the function information associated with the intention information based on the speech.

5. The method of claim 4, wherein the generating a recognition result of the speech based on the intention information and the second content information, comprises:
inputting the intention information and the second content information into the speech recognition model to output and obtain the recognition result of the speech.

6. The method of claim 1, wherein the determine second content information based on the first content information through an application programming interface (API) corresponding to the function, comprises:
transferring the first content information to the API as a parameter of the API; and
receiving the second content information returned by the API based on the parameter.

7. The method of claim 6, wherein the API is used for performing a fuzzy search based on the first content information to determine the second content information.

8. The method of claim 1, wherein the generating a recognition result of the speech based on the intention information and the second content information, comprises:
splicing the intention information and the second content information to generate the recognition result of the speech.

9. The method of claim 1, further comprising:
in response to the first content information recognized matching the speech, generating the recognition result of the speech based on the intention information and the first content information.

10. The method of claim 1, wherein the intention information comprises an intention related to music playing, and the first content information comprises at least one selected from the group of a song name, a singer, a lyricist and a composer.

11. A computer device, comprising at least one processors, a memory, and at least one programs, wherein the at least one programs are stored in the memory and executed by the at least one processors, and the programs comprise instructions for causing a method for speech recognition to be performed, wherein the method for speech recognition comprises:
receiving a speech input by a user;
recognizing the speech to determine first content information and intention information corresponding to the speech, and function information associated with the intention information;
in response to the first content information recognized failing to match the speech, calling a function corresponding to the function information to determine second content information based on the first content information through an application programming interface (API) corresponding to the function; and
generating a recognition result of the speech based on the intention information and the second content information.

12. The computer device of claim 11, wherein the processor is further configured to:
acquire a plurality of keywords associated with the intention information;
in response to the first content information recognized failing to match the plurality of keywords, determine that the first content information recognized fails to match the speech; or
in response to the first content information recognized matching a target keyword among the plurality of keywords, determine that the first content information recognized matches the speech.

13. The computer device of claim 12, wherein the plurality of keywords comprise at least one selected from the group consisting of a plurality of words and a plurality of phrases in a field associated with the intention information which are searched for more than a preset number of times within a preset time period.

14. The computer device of claim 11, wherein the recognizing the speech to determine first content information and intention information corresponding to the speech, and function information associated with the intention information, comprises:
calling a speech recognition model to output the first content information and the intention information corresponding to the speech, and the function information associated with the intention information based on the speech.

15. The computer device of claim 14, wherein the generating a recognition result of the speech based on the intention information and the second content information, comprises:
inputting the intention information and the second content information into the speech recognition model to output and obtain the recognition result of the speech.

16. The computer device of claim 11, wherein the determine second content information based on the first content information through an application programming interface (API) corresponding to the function, comprises:
transferring the first content information to the API as a parameter of the API; and
receiving the second content information returned by the API based on the parameter.

17. The computer device of claim 16, wherein the API is used for performing a fuzzy search based on the first content information to determine the second content information.

18. The computer device of claim 11, wherein the generating a recognition result of the speech based on the intention information and the second content information, comprises:
splicing the intention information and the second content information to generate the recognition result of the speech.

19. The computer device of claim 11, wherein the processor is further configured to:
in response to the first content information recognized matching the speech, generate the recognition result of the speech based on the intention information and the first content information.

20. A non-volatile computer-readable storage medium, wherein a computer program is stored on the non-volatile computer-readable storage medium, the computer program, when executed by at least one processors, causes the processors to execute a method for speech recognition, wherein the method for speech recognition comprises:
receiving a speech input by a user;
recognizing the speech to determine first content information and intention information corresponding to the speech, and function information associated with the intention information;
in response to the first content information recognized failing to match the speech, calling a function corresponding to the function information to determine second content information based on the first content information through an application programming interface (API) corresponding to the function; and
generating a recognition result of the speech based on the intention information and the second content information.
